(19) United States
(12) Patent Application Publication
(10) Pub. No.: US 2016/0015161 A1
(43) Pub. Date: Jan. 21, 2016

(54) CHILD TOOTHBRUSH

(71) Applicant: Whitney Anne Mullen, Santee, CA (US)

(72) Inventor: Whitney Anne Mullen, Santee, CA (US)

(21) Appl. No.: 14/799,755

(22) Filed: Jul. 15, 2015

Related U.S. Application Data
(60) Provisional application No. 62/024,866, filed on Jul. 15, 2014.

(51) Int. Cl. A46B 5/04; A46B 1/00; A61C 3/00

(52) U.S. Cl. CPC A46B 5/04; A61C 3/005; A46B 1/00

(57) ABSTRACT

A child toothbrush may include a hollow tube. The hollow tube may include a first end. The first end may be open to allow a finger to enter the tube. The hollow tube may also include an outer surface and a first material. The first material may be flexible. The hollow tube may additionally include a second material. The second material may be less flexible than the first material. The child toothbrush may also include a plurality of protrusions distributed on the outer surface.

### CROSS-REFERENCES TO RELATED APPLICATIONS

This application claims the benefit of U.S. Provisional Application No. 62/024,866 filed on Jul. 15, 2014 entitled “CHILD TOOTHBRUSH,” the entirety of which is hereby incorporated by reference.

### BRIEF SUMMARY

A child toothbrush may include a hollow tube. The hollow tube may include a first end. The first end may be open to allow a finger to enter the tube. The hollow tube may also include an outer surface and a first material. The first material may be flexible. The hollow tube may additionally include a second material. The second material may be less flexible than the first material. The child toothbrush may also include a plurality of protrusions distributed on the outer surface.

### BRIEF DESCRIPTION OF THE DRAWINGS

A further understanding of the nature and advantages of the present invention may be realized by reference to the remaining portions of the specification and the drawings, wherein like reference numerals are used throughout the several drawings to refer to similar components.

FIG. 1 illustrates a diagram of a hollow tube of a child toothbrush, according to some embodiments.

FIG. 2 illustrates a diagram of a hollow tube with a plurality of protrusions, according to some embodiments.

FIG. 3 illustrates a diagram of rigid or semi-rigid structure for the tube, according to some embodiments.

FIG. 4 illustrates a diagram of the rigid or semi-rigid structure of the tube with an end cap 406, according to some embodiments.

FIG. 5 illustrates a diagram of another geometry for the rigid or semi-rigid structure, according to some embodiments.

FIG. 6 illustrates a diagram of the first and second materials of the toothbrush, according to some embodiments.

FIG. 7 illustrates a diagram of the first material and the second material including a plurality of protrusions, according to some embodiments.

FIG. 8 illustrates a three-dimensional diagram of the same configuration as that of FIG. 7, according to some embodiments.

FIG. 9 illustrates a diagram of an embodiment with the second material forming a continuous, solid, rigid or semi-rigid support structure, according to some embodiments.

FIG. 10 illustrates a diagram of a bottom view of the child toothbrush, according to some embodiments.

FIG. 11A illustrates a diagram of an embodiment of the second material that is rigid or semi-rigid.

FIG. 11B illustrates a diagram of a side cutaway view of the second material of FIG. 11A.

FIG. 12 illustrates a diagram of the first material that can fit over the second material of FIGS. 11A-B.

FIG. 13 illustrates a diagram of the first material laid over the top of the second material.

FIGS. 14A-14C illustrate diagrams of a fully formed child toothbrush.

FIG. 15 illustrates a flowchart of method for constructing the child toothbrush, according to some embodiments.

### DETAILED DESCRIPTION

Described herein, are embodiments of a children's toothbrush that allows a brusher, e.g. a parent of caregiver, to have greater control than when using a handheld product with a handle to brush the teeth and/or gums of a secondary user, e.g. a child. These embodiments provide for a finger-fitted dental device that uniquely addresses a common issue for brushing a child's teeth, namely biting of the toothbrush device. Children often bite anything that is inserted into their mouths. When using a handled toothbrush, biting children can destroy the bristles and otherwise prevent effective toothbrushing from taking place. This problem is compounded when the brusher has to insert his/her finger into the child's mouth. When biting occurs, the brushing session can abruptly end before the teeth can be effectively brushed. Additionally, the painful experience of being bitten may also reduce future brushing sessions in quality, regularity, and/or duration, all of which are vital components of effective oral healthcare in children. The embodiments described herein may improve the experience by minimizing pain for the brusher, providing the brusher greater control, and may thereby more effectively clean the child's teeth.

When a child is experiencing tooth eruption, biting is a natural and healthy tendency. Biting helps the teeth emerge from the gums and helps the child form a natural chewing habit. Teething is a vital time to support the health of the emerging teeth by brushing. Not only is brushing effective to remove or dislodge harmful bacteria, but it also massages the area and can bring comfort to the child by reducing gum irritation. Prior to this disclosure, brushing discouraged biting by causing painful reactions in the brusher and reducing the effectiveness of the toothbrush. The embodiments described herein allow for biting to take place comfortably during brushing while still providing an effective toothbrushing experience.

In some embodiments, the child toothbrush may include a hollow tube with an opening in one end to allow a finger of the brusher to be inserted. The outer surface of the tube may have distributed thereon a plurality of protrusions that can be used to massage the gums and/or brush the teeth. The tube can include at least two materials. The first material may be relatively soft and flexible and may coat the outer portion of the tube. The first material on the outer portion of the tube will generally come in contact with the child's teeth and gums, and the flexible material can allow the child to bite down on the toothbrush without immediately contacting a rigid surface that would be uncomfortable on the child's gums. The tube may also include a second material that may be relatively hard or rigid compared to the first material. The second material can provide a structure or frame that helps the child toothbrush maintain its shape during the brushing process and protects the finger of the brusher from the pressure and/or puncture of bites—whether intentional or accidental—as the child bites down on the toothbrush. Different embodiments will provide different configurations of the first material and the second material, and will be described in greater detail below.

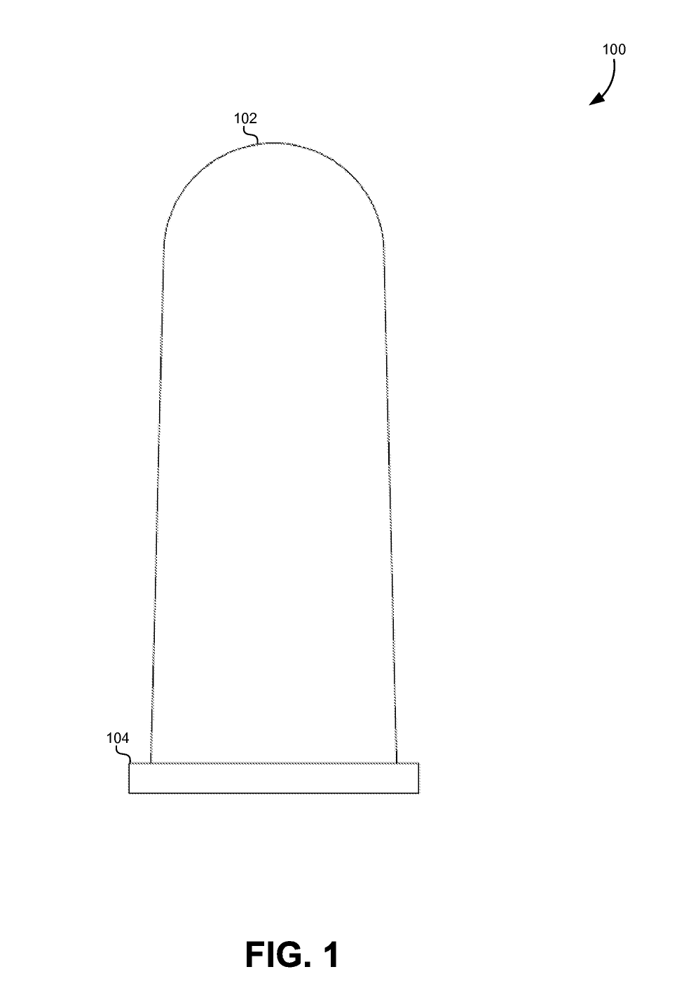

FIG. 1 illustrates a diagram 100 of a hollow tube of a child toothbrush, according to some embodiments. Diagram 100 generally shows the shape of the of the tube without regard to the internal structure or the first and/or second materials. Any protrusions, such as bristles or nubs have also been omitted from diagram 100 in order to focus on the shape of the tube itself. These will be described in detail below. The tube may include a base 104 that is open to allow a finger to be inserted into the base 104. The tube may also include a closed end 102 that is curved or otherwise contoured to fit the contour of the end of a human finger. The tube can generally taper from the base 104 to the closed-end 102 such that the tube decreases in diameter towards the closed end 102. In other embodiments, the tube can be a generally uniform diameter in order to make manufacturing easier. In some embodiments, the tube can be contoured throughout its length to mimic the contour of the human finger. Therefore, it may include a flex or bendable region or indentation around one or more of the locations corresponding to human knuckles. The closed end 102 may be rounded so as to fit the contour of the tip of the human finger. In other embodiments, the closed end 102 can be removed and both ends of the tube can be open. Although diagram 100 shows a closed structure for the tube, other embodiments can have perforations or other openings in the tube to expose the interior portion the tube along its length. These perforations, holes, and/or cavities in the tube can be filled with medications, frozen liquid, or other applications that are designed to alleviate teething pain. The base 104 can be a generally larger diameter than the remainder of the tube, thereby forming a lip that a brusher can hold to take the toothbrush on and off of the brusher's finger. The lip of the base 104 can be square shaped, rounded, and/or the like. The base 104 can also include an elastic material that holds the toothbrush on the brusher's finger.

The tube can be manufactured of many different materials. Some embodiments may use a rubber or silicone material for the outer surface of the tube. Materials like these can provide a flexible and forgiving surface the child can be encouraged to bite down upon. Generally, the outer surface of the tube will correspond to the first material described above, being generally more flexible and less rigid than the second material. This first material can be colored in many different colors. Some embodiments may color the first material to match the skin tone of the user. A number of different flesh-colored tubes can be manufactured to match the varying skin tones of users of different races. This can make the toothbrush less noticeable when inserting the toothbrush into the child's mouth such that it will look like a natural part of the brusher's finger. Alternatively or additionally, the first material of the tube can include graphics, bright colors, and/or other pictures that might be enticing to a child, such as popular cartoon characters, animals, and cars and trucks, and/or the like. Alternatively, the first material may be clear and the second material may be colored in many different colors.

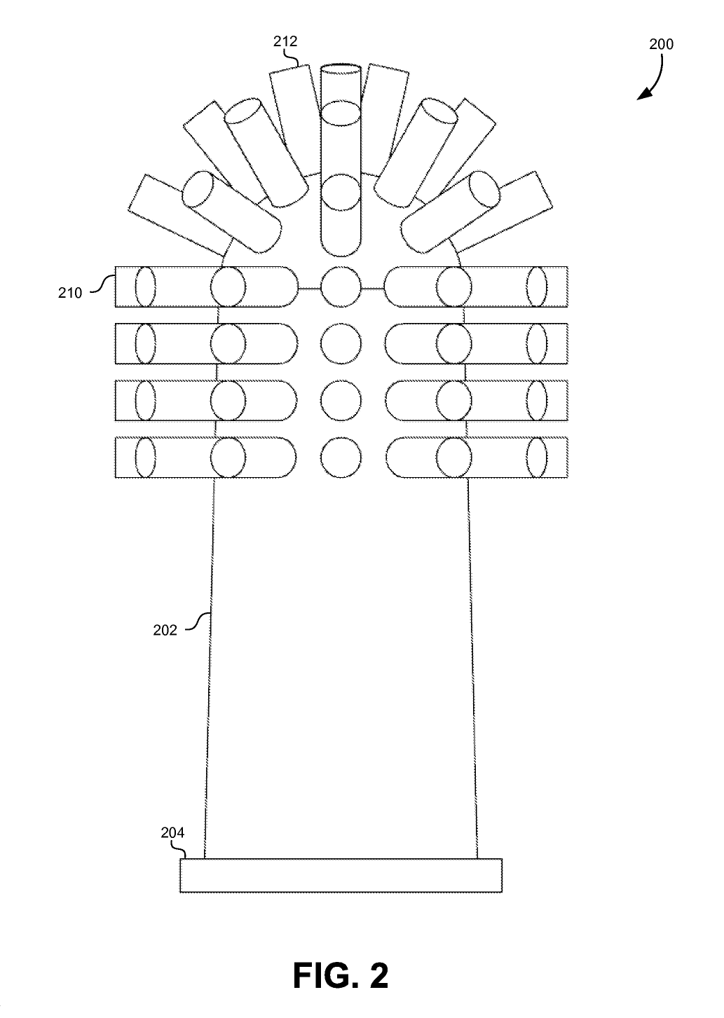

FIG. 2 illustrates a diagram 200 of a hollow tube with a plurality of protrusions, according to some embodiments. The protrusions 210, 212 may be arranged in any pattern and distributed on the outer surface of the tube 202 according to various embodiments. In the embodiment illustrated in diagram 200, the protrusions 210, 212 are uniformly shaped cylinders that radiate orthogonally from the body of the tube 202. In other embodiments not explicitly shown, the protrusions 210, 212 may also include nylon bristles such as those found on traditional toothbrushes, rounded nubs or bumps more suited for massaging new teeth, protrusions with a round base that gradually taper as they extend further from the tube 202, triangles or cones that come to a point, and/or the like. The protrusions 210, 212 can also be uniformly shaped in noncircular geometries, such as squares, triangles, pentagons, and/or other polygons. Some embodiments may mix-and-match different types of the protrusions 210, 212 described above. For example, some embodiments may use round uniform bristles through the closed end of the tube 202, rounded nubs in the upper body of the tube, and pointed cones towards the bottom of the tube. Nubs and/or cones may be more beneficial for younger children, while bristles may better accommodate older children with more established teeth. Therefore, various versions of the toothbrush can be constructed and targeted to children of different ages.

In diagram 200, body protrusions 210 radiate orthogonally from the body of the tube 202. In this embodiment, the lower portion of the tube 202 does not include body protrusions 210. The lower portion of the tube 202 may be more likely to interface with the child's lips, and therefore the surface may remain smooth without protrusions to avoid irritating the mouth and lips of the child. Other embodiments may extend the body protrusions 210 throughout the entire length of the body of the tube 202 to various degrees. Some embodiments may use protrusions of varying length along the body of the tube 202. For example, protrusions may start out very small near the base 204, while gradually becoming longer in length towards the closed end of the tube 202.

Generally, the protrusions 210, 212 can cover any portion of the tube 202. In diagram 210, the protrusions 210 cover all 360° of the tube 202 such that bristles radiate outwardly in all directions. This may be advantageous for being able to wear the toothbrush in any orientation on the finger and for being able to brush the child's teeth in any direction. Other embodiments may include bristles on opposite sides of the tube so as to allow the parent to brush the chewing surfaces of the top teeth on a bottom teeth simultaneously without brushing the tongue or cheek. Some embodiments include a first type of protrusion on one side of the tube 202 and a second type of protrusion on the opposite side of the tube 202. For example, one side of the tube could include long bristles, while the other side of the tube could include rounded nubs. This can allow the brusher to brush in one set of teeth while massaging the opposite (top/bottom) set of teeth/gums.

Some embodiments may also include end protrusions 212 that radiate be outwardly from the closed end of the tube. As illustrated in diagram 200, protrusions can cover the curved surface of the end of the tube 202. As with the body protrusions 210, the end protrusions 212 can be mixed and matched with various protrusion types, and may be arranged in any pattern. By way of example, the protrusions can comprise bristles having a thickness of 0.035 inches to 0.150 inches. The bristles may be 0.07 inches to 0.5 inches in length, and may have a taper of between 0° and 30°.

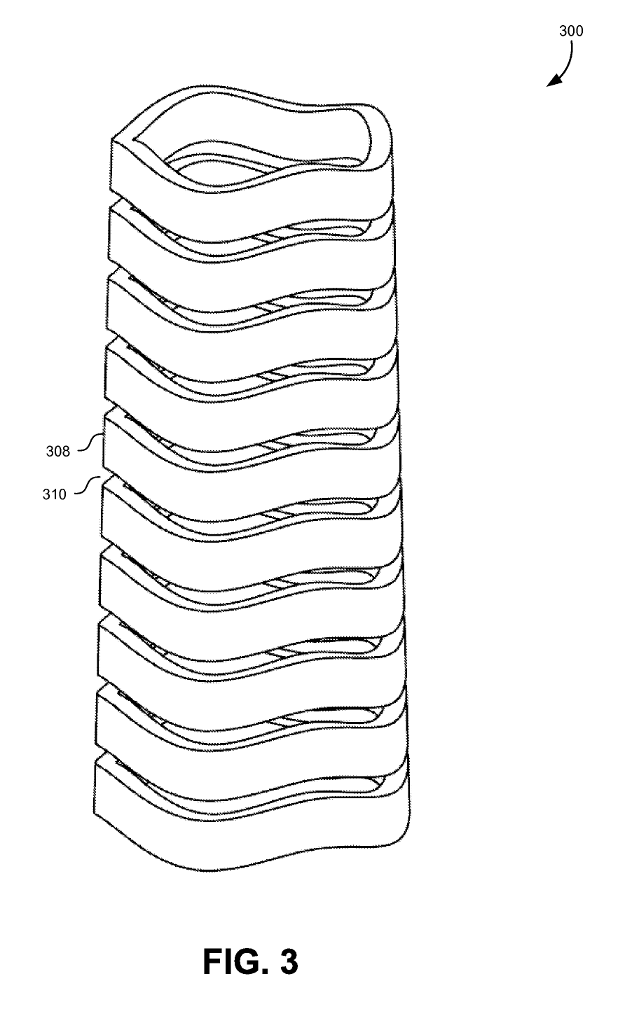

FIG. 3 illustrates a diagram 300 of rigid or semi-rigid structure for the tube, according to some embodiments. For clarity, the rigid or semirigid structure for the tube is illustrated in diagram 300 without a flexible portion of the tube (the first material) or the protrusions. The rigid or semirigid structure may comprise the second material described above that is less flexible than the first material that makes up the outer surface of the tube. The first material can be a plastic, a thermoplastic polymer, a polyester material, and/or the like. By way of example, the first material may include high-density polyethylene (HDPE), low-density polyethylene (LDPE), copolyester, polyethylene terephthalate (PET), polypropylene (PP), polylactide (PLA), nylon, and/or other similar materials. These materials may be formed into a structure that is flexible, yet more rigid than the first material described above. The second material may also be formulated such that it is semi-rigid, allowing for the overall structure to flex as a child bites down on the toothbrush. The second material may also be formed such that it is rigid.

The second material can be formed in many different geometries to provide a rigid or semi-rigid structure for the tooth brush. In diagram 300, the structure takes the form of a plurality of stacked hollow rings 308. These rings can line the interior of the hollow tube of the tooth brush. A small gap 310 between each ring can allow the hollow tube to flex and bend. The profile of each ring 308 can vary, depending on the embodiment. The rings 308 in diagram 300 have a uniform thickness and a wavy pattern. Other ring configurations can have a uniform thickness with a straight pattern. Other ring configurations can have varying thicknesses. For example, one embodiment may have rings that are thicker on the top side of the toothbrush and thinner on the bottom side of the toothbrush, allowing the hollow tube to flex more readily with the brusher's finger. Additionally, the diameter of the rings can either be uniform, or can vary along the length of the hollow tube. For example, the rings could have a larger diameter at the base of the tube and gradually decreasing diameter towards the top of the tube. The diameter of the rings could also follow the diameter of a typical brusher's finger as it tapers towards the end of the hollow tube.

The number of rings may vary according to the particular embodiment. Some embodiments may have as few as two or three rings, while other embodiments may have as many as 15 to 20 rings. Generally, embodiments with more rings can have shorter rings, while embodiments with fewer rings may have taller rings. In some embodiments, the thickness of the rings can vary between 0.03 and 0.25 inches. The overall length of the rigid or semi-rigid structure can be 1.5 to 3 inches. As described above, the diameter of the rigid or semi-rigid structure can taper from the base of the hollow tube to the top of the hollow tube. This taper can be anywhere between 0° and 15°.

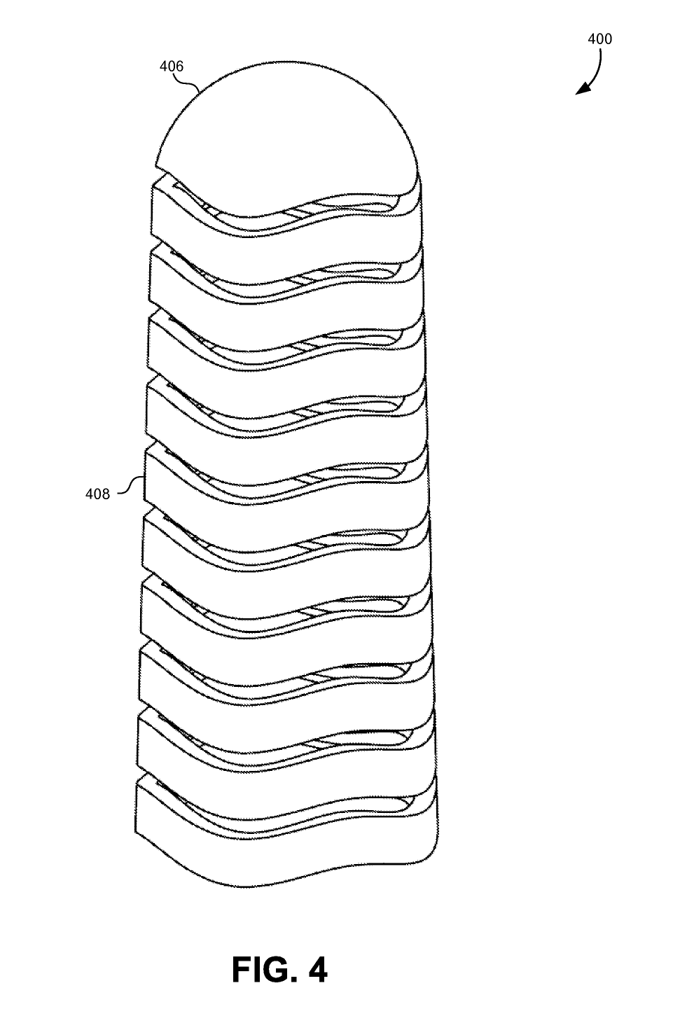

FIG. 4 illustrates a diagram 400 of the rigid or semi-rigid structure of the tube with an end cap 406, according to some embodiments. The end cap 406 may be constructed using the same material as the rings 408. Alternatively, the end cap 406 may be constructed using a different material. For example, the end 406 may be constructed with a more flexible material than that which is used to construct the rings 408.

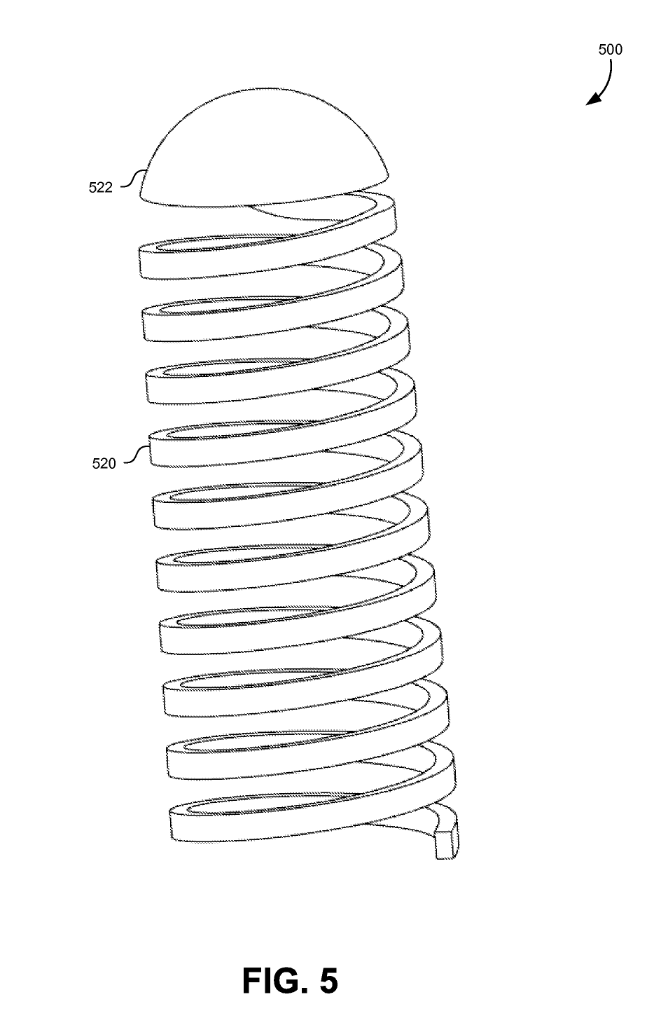

FIG. 5 illustrates a diagram 500 of another geometry for the rigid or semi-rigid structure, according to some embodiments. Instead of using separate rings, this embodiment uses a rigid or semi-rigid structure that is formed into a single geometry. Diagram 500 illustrates this single geometry as a spiral 520 that terminates at an end cap 522. As with the ring embodiments described above, the end cap 522 can be omitted. The spiral 520 can be a uniform diameter through the length of the tube, or may vary in diameter to gradually taper towards the end of the tube. The spiral 520 can include a single, flat-sided spiral support structure made of, for example, a thermoplastic. The profile of the spiral can vary to have taller or shorter sides and may include less space between each rotation to make for a tighter spiral shape.

The single-geometry construction may be easier to form, and may also be easier to combine with the first flexible material described above during the manufacturing process. Other single-geometry constructions may include a net-like structure that includes holes or cavities in the rigid or semi-rigid structure that allow for some flexibility and/or the impregnation of the first flexible material. The holes in the net-like structure can be round, square, diamond shaped, and/or any other shape. In another embodiment, the rigid or semi-rigid structure may comprise a continuous tube of material without rings, holes or other cavities required.

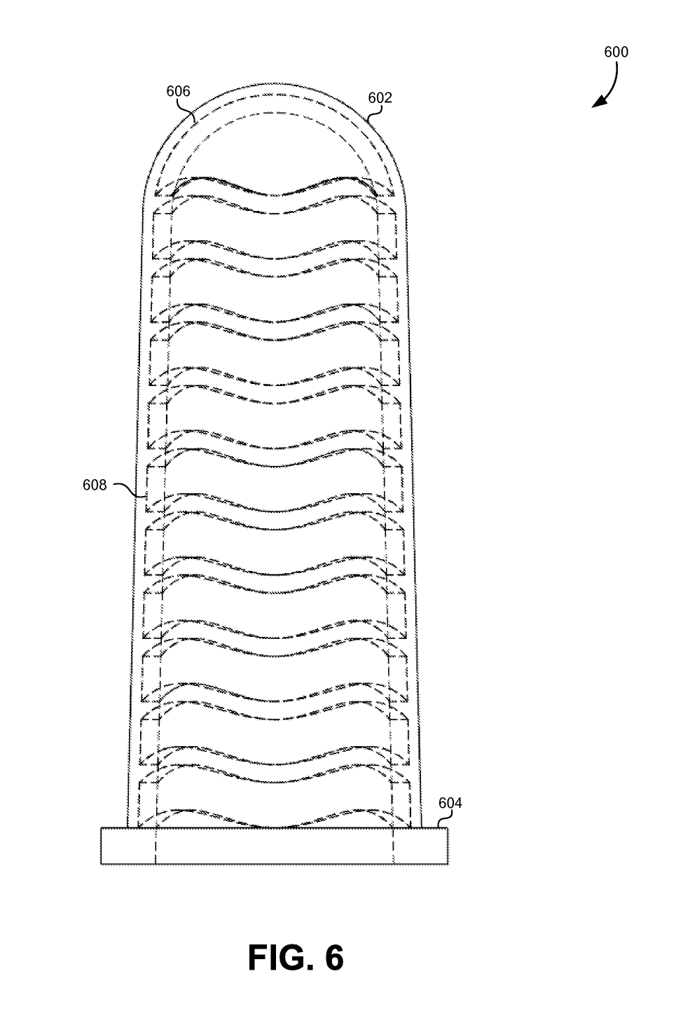

FIG. 6 illustrates a diagram 600 of the first and second materials of the toothbrush, according to some embodiments. This embodiment illustrates the second material 608 of the rigid or semi-rigid structure integrally formed with the first material 602. In this embodiment, the second material 602 forms the outer surface of the toothbrush such that the second material 608 is not exposed to the child's teeth during the brushing process. The first material 602 also fill the spaces between the rings of the second material 608. During the manufacturing process, the rigid or semi-rigid structure made of the second material 608 can be inserted into an injection mold, in the first material 602 can be injected or compressed and formed around the second material 608. In some cases, the second material 608 can be completely enclosed in the first material 602, providing a padded surface for the brusher's finger. In other cases, the second material 608 can be exposed to the interior of the hollow tube.

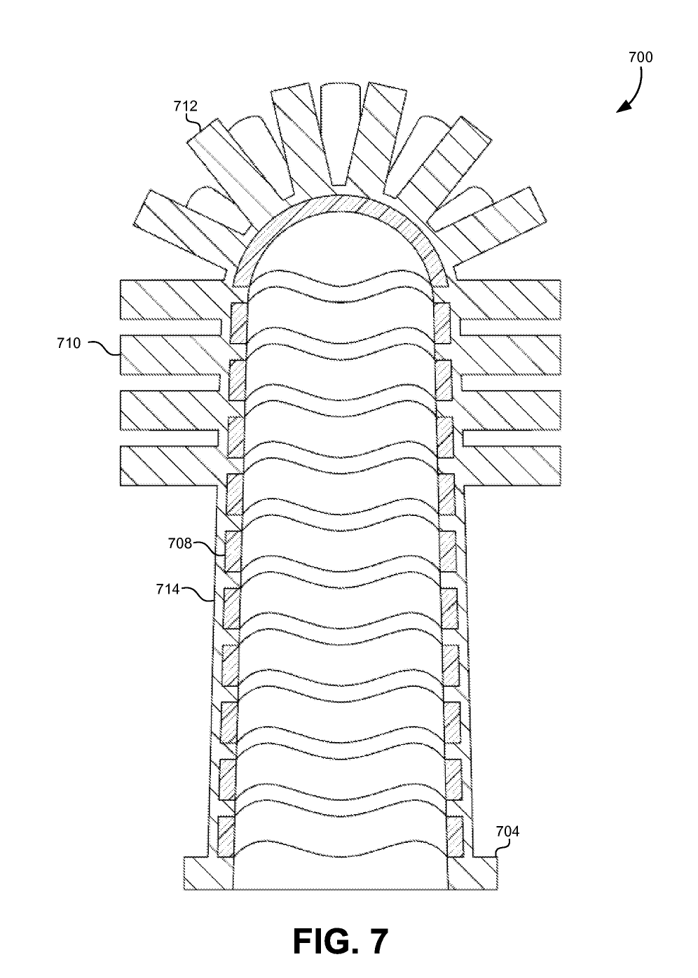

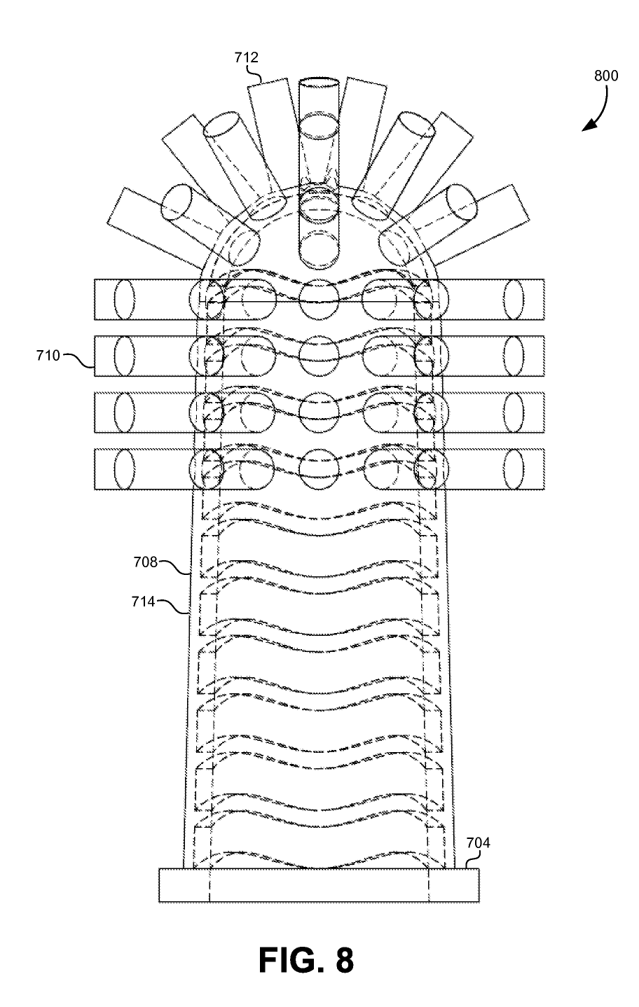

FIG. 7 illustrates a diagram 700 of the first material and the second material including a plurality of protrusions, according to some embodiments. This embodiment illustrates the combination of the second material 708 forming the rigid or semi-rigid support structure, the first material 714 forming the flexible surface, the base 704, the side protrusions 710, and the top protrusions 712. The rigid or semi-rigid support structure and/or the various protrusions can be substituted by various configurations described above without limitation. FIG. 8 illustrates a three-dimensional diagram 800 of the same configuration, according to some embodiments.

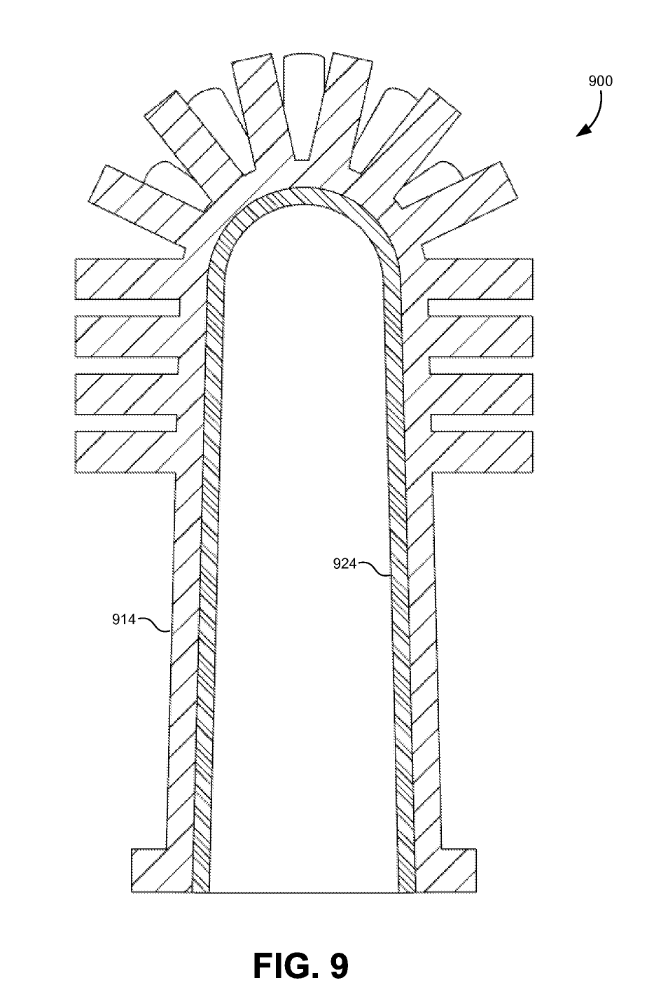

FIG. 9 illustrates a diagram 900 of an embodiment with the second material forming a continuous, solid, rigid or semi-rigid support structure, according to some embodiments. The second material 924 can be formed into a solid finger-shaped tube with an open or closed end. The first material 914 can form a flexible surface to coat the second material 924. Some embodiments may include additional materials on the interior of the second material 924 to provide a comfortable surface for the brusher's finger. For example, some embodiments may also coat the interior of the second material 924 with an additional layer of the first material 914.

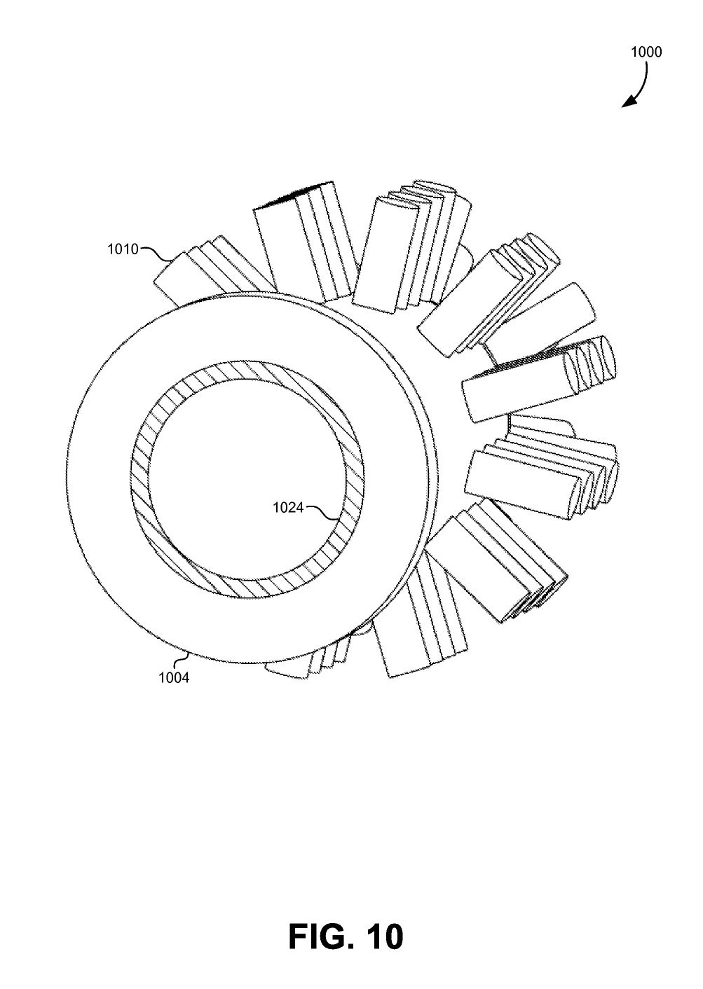

FIG. 10 illustrates a diagram 1000 of a bottom view of the child toothbrush, according to some embodiments. Diagram 1000 illustrates how the protrusions 1010 can radiate outwardly from the hollow tube in any and/or all directions. The second material 1024 may be visible on the bottom of the hollow tube, and may be surrounded by the base 1004 formed out of the first material. Other embodiments may cover the base of the second material 1024 with the first material.

FIGS. 1-9 have described and illustrated general concepts that may be followed in designing a child toothbrush. The remainder of this disclosure will describe a particular embodiment of the child toothbrush that uses specific implementations of the broad principles described above. It will be understood that the embodiment that is discussed below is merely exemplary and not meant to be limiting.

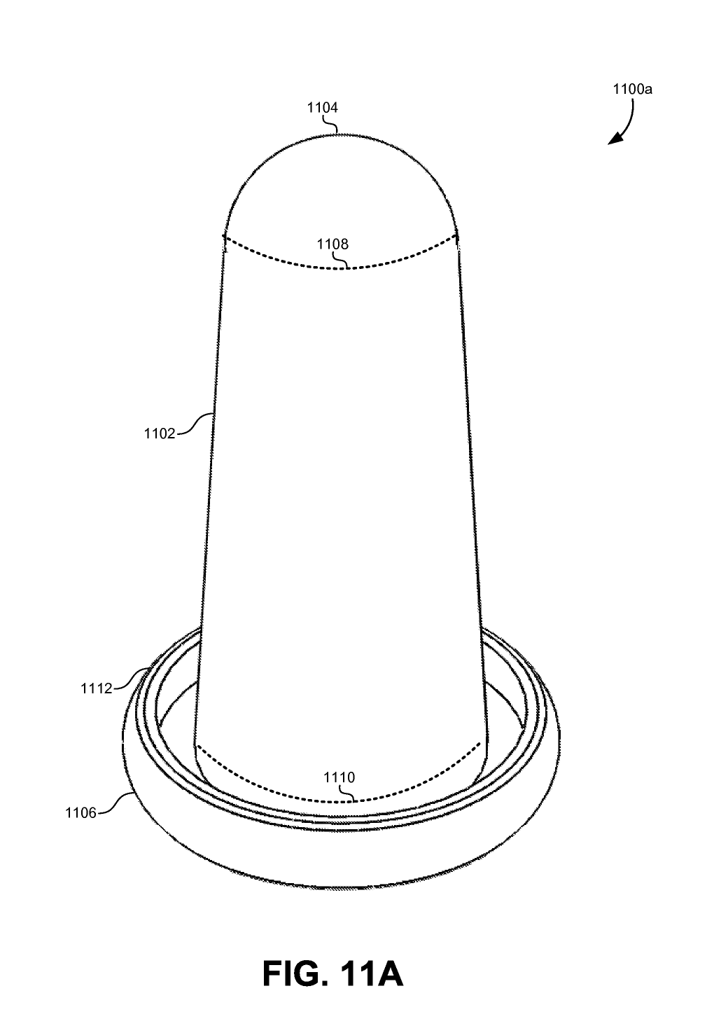

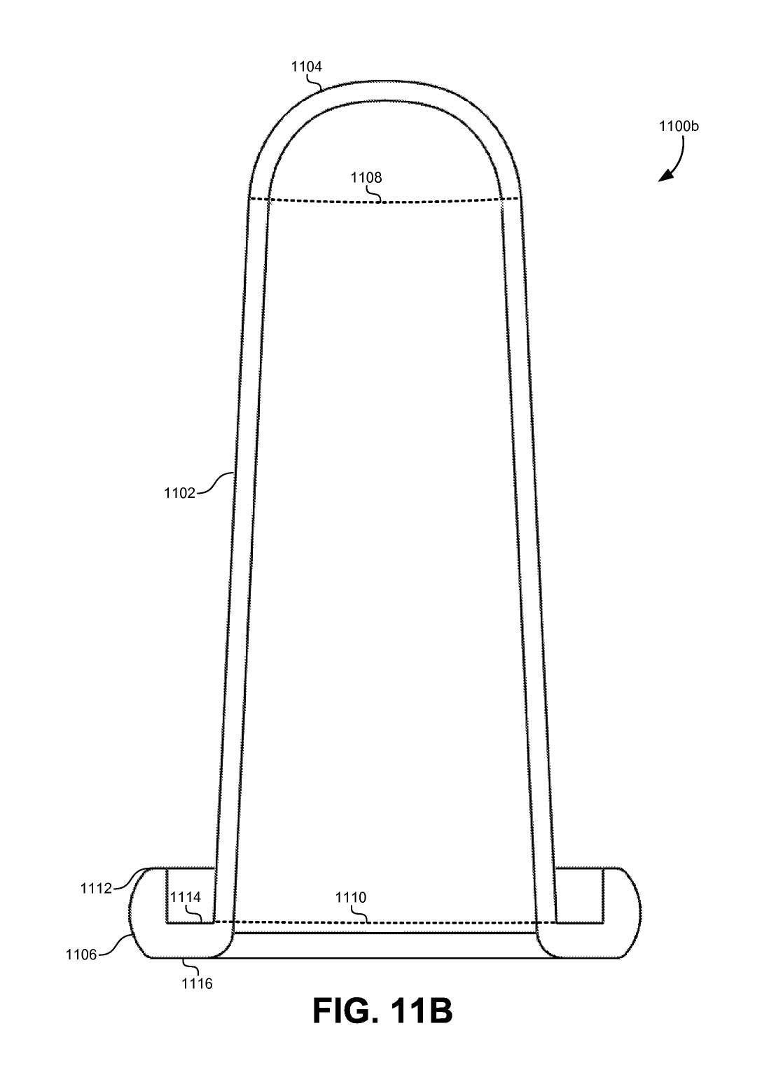

FIG. 11A illustrates a diagram 1100a of an embodiment of the second material that is rigid or semi-rigid. In this embodiment, the second material forms a tube 1102 with a closed end 1104. The tube 1102 includes a tapered profile that begins at a first circumference 1110 towards a base 1106 of the tube 1102 and gradually tapers to a second circumference 1108 near the closed end 1104 of the tube. The first circumference 1110 is larger than the second circumference 1108. The closed end 1104 forms a rounded cap and has a continuously smooth transition from the center section of the tube 1102. The base 1106 of the tube 1102 extends perpendicularly from the bottom of the tube 1102 exposing a flat bottom such that the child toothbrush can stand on a flat surface without falling over. The base 1106 also includes a lip 1112 that extends upwards towards the top of the tube 1102. The lip 1112 forms a trough between the bottom of the tube 1102 and the lip 1112.

FIG. 11B illustrates a diagram 1100b of a side cutaway view of the second material of FIG. 11A. Diagram 1100b illustrates how the diameter of the tube 1102 can gradually taper from the first circumference 1110 to the second circumference 1108. Diagram 1100b also illustrates how the trough 1114 is formed between the lip 1112 and the tube 1102. A flat bottom portion 1116 is formed by the base 1106 such that the child toothbrush can stand on a flat surface.

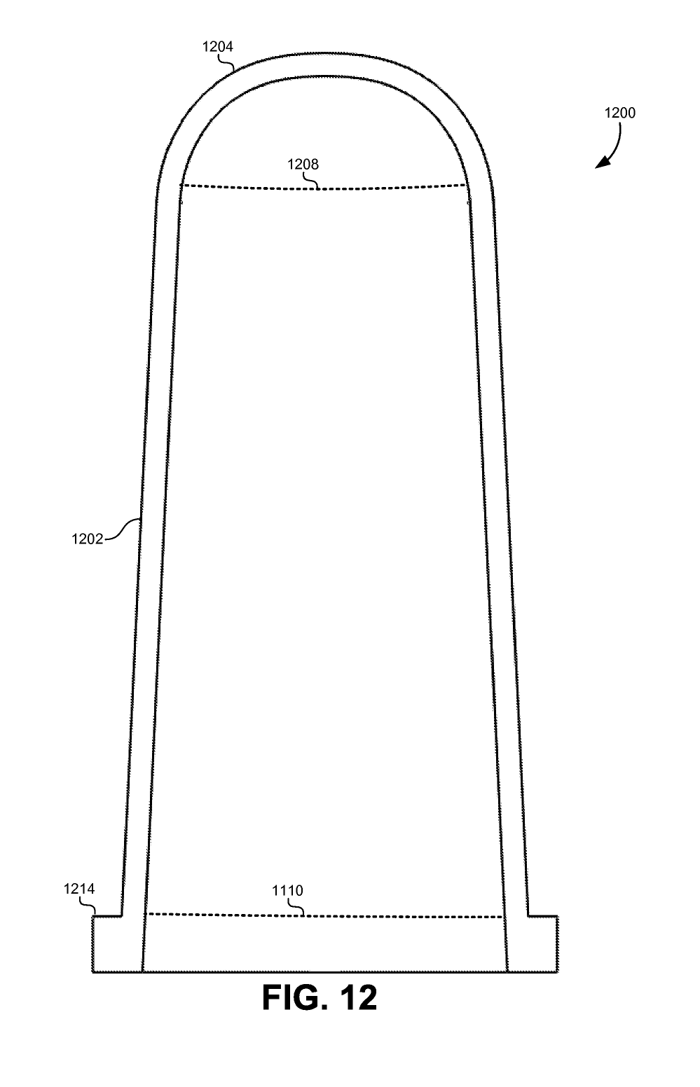

FIG. 12 illustrates a diagram 1200 of the first material that can fit over the second material of FIGS. 11A-B. The first material also includes a tube 1202 and a closed end 1204 that is rounded. Generally, the interior dimensions of the first material will conform with the exterior dimensions of the second material. For example, near the top of the tube 1102, a first interior circumference 1210 of the first material will be approximately the same as the first circumference 1110 (exterior) of the second material. Similarly, a second interior circumference 1208 of the first material will be approximately the same as the second circumference 1108 (exterior) of the second material. The contour of the closed end 1204 of the first material will substantially conform to the contour of the closed end 1104 of the second material. The first material will also include a ring 1214 that protrudes around the base of the first material. The ring 1214 is sized to fit within the dimensions of the trough 1114 of the second material.

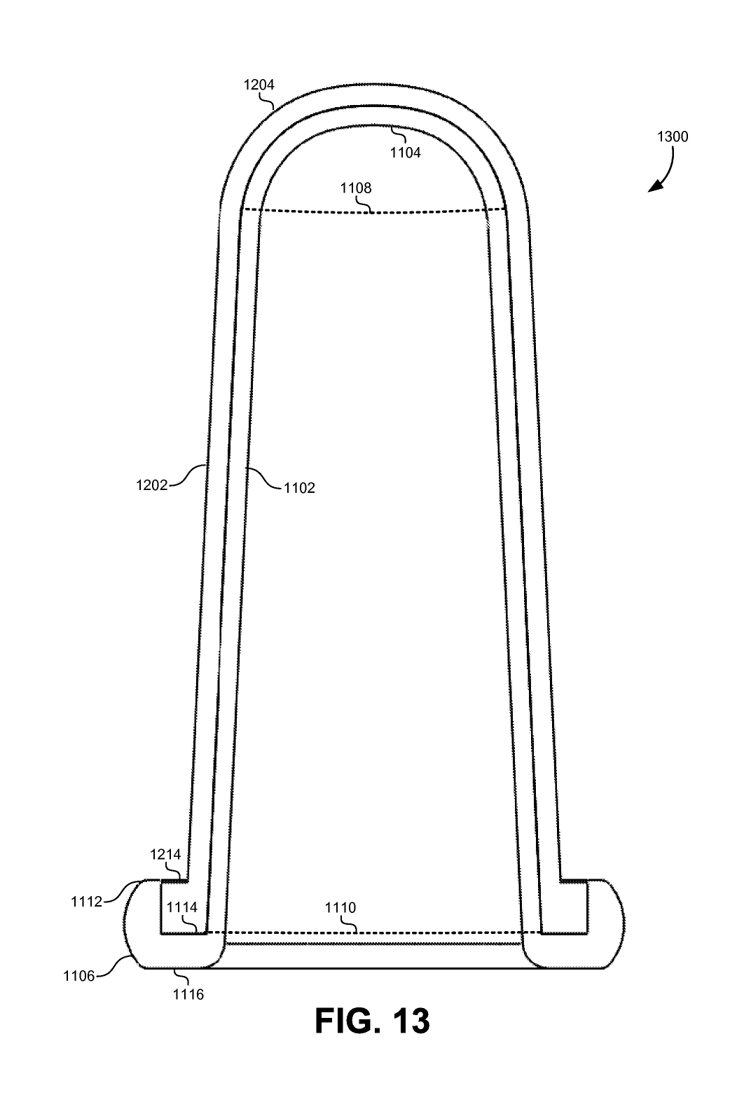

FIG. 13 illustrates a diagram 1300 of the first material laid over the top of the second material. Note that the ring 1214 of the first material fits within the trough 1114 of the second material. Also note that the shape of the first material substantially conforms to the shape of the second material. In order to form the combination of the first material and the second material, the second material may first be formed using an injection molding process. After the injection molding process the second material may substantially cure to become rigid, or semi-rigid. The second material can then be inserted into a second mold, where the second material forms an interior portion of the mold and the second mold forms the exterior portion of the mold. The first material can then be injected into the combination of the second mold and the second material where it cures into a flexible consistency. This method ensures that the first material adheres to the second material and substantially forms around the second material. In alternative embodiments, both the second material and the first material may be formed individually in their own injection molds. After the first and second materials are cured, the second material may be inserted into the first material.

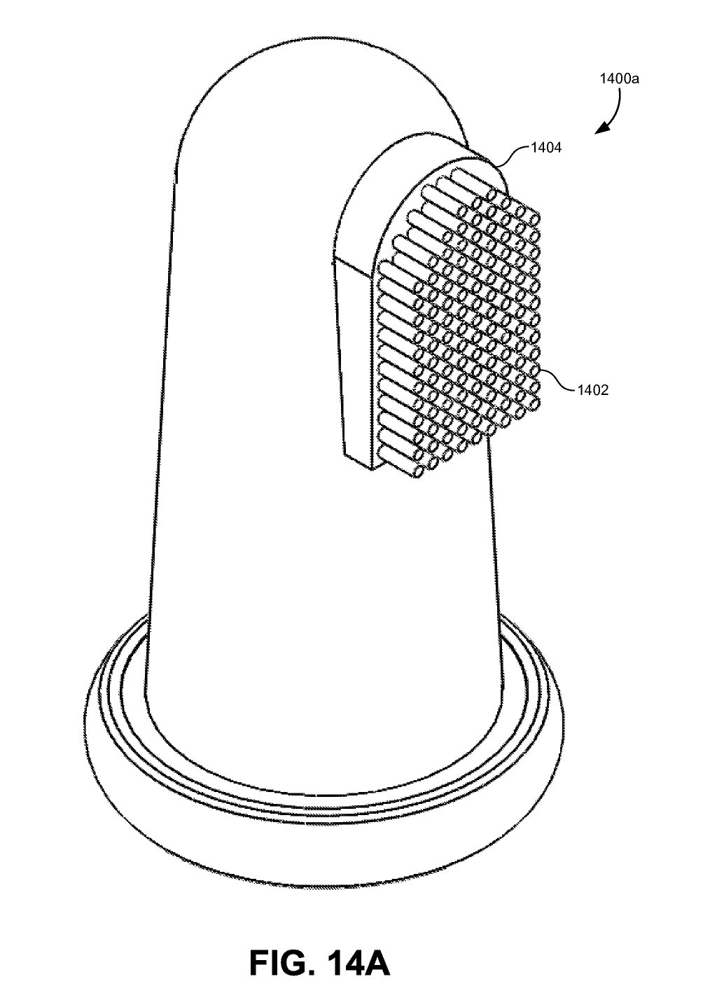

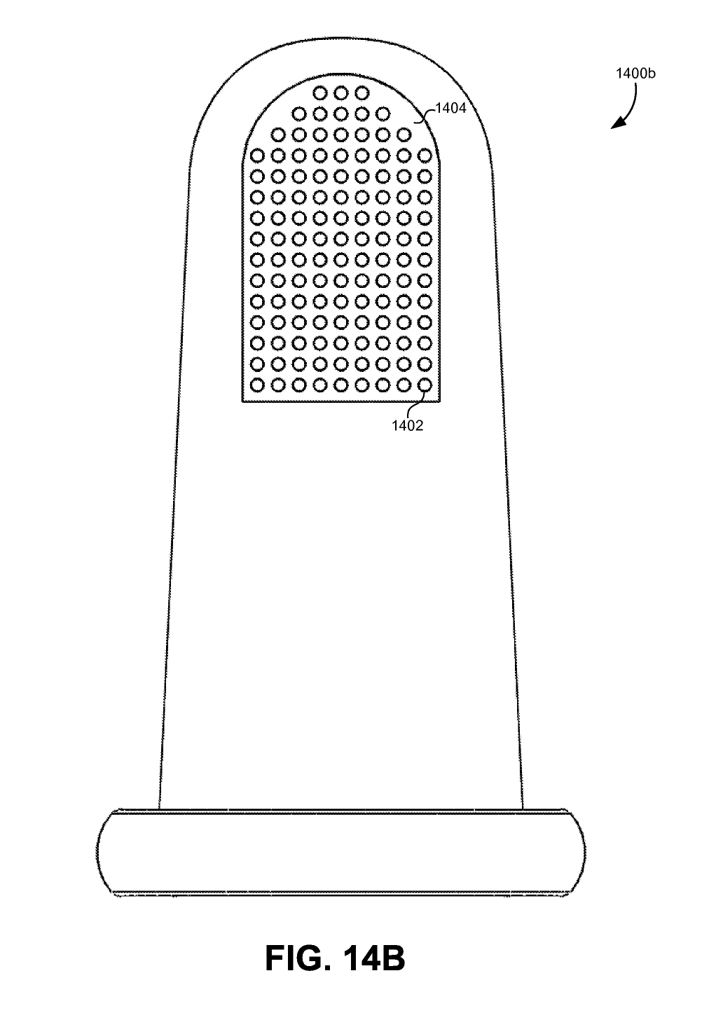

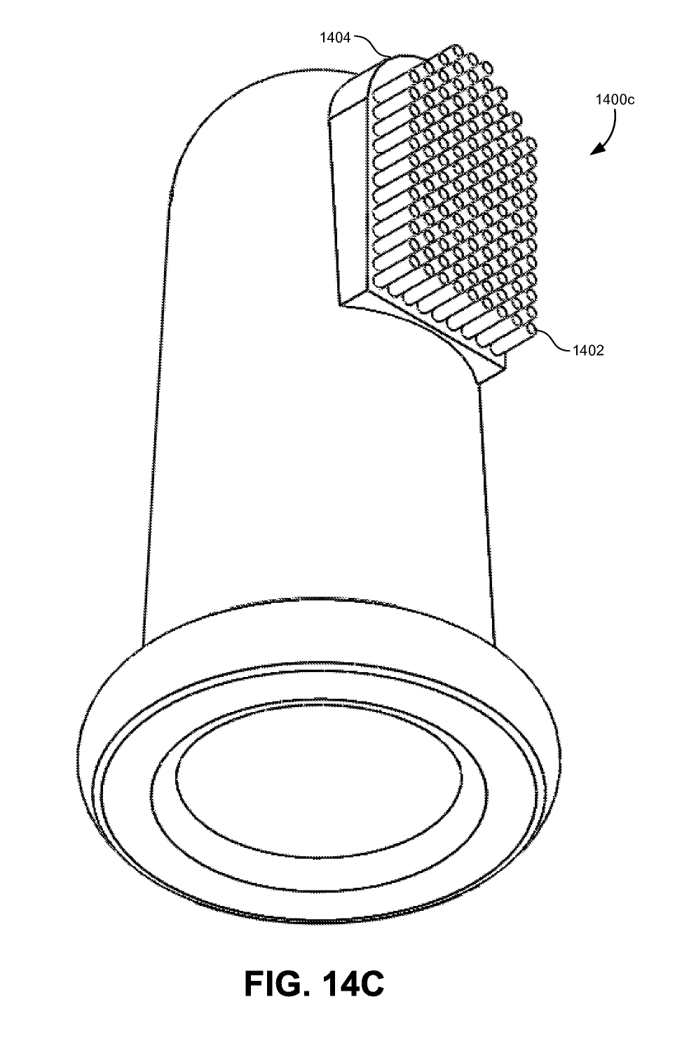

FIGS. 14A-14C illustrate diagrams 1400a-c of a fully formed child toothbrush. These diagrams illustrate the combination of the first material and second material as described above. These diagrams also illustrate a particular arrangement of protrusions 1402 to be used as a brush during the toothbrushing process. The brush portion includes a platform 1404 and a plurality of protrusions 1402. The platform 1404 serves to transition between the curved contour of the tube 1202 and a flat surface on which the protrusions 1402 can be based. Traditional toothbrushes have bristles that extend perpendicular to a flat surface. The platform 1404 provides a flat surface such that the protrusions 1402 can extend in a uniform orientation, direction, and length.

In some embodiments, the platform 1404 and protrusions 1402 can be formed as part of the same injection molding process as the first material. The platform 1404 and the protrusions 1402 can thus be formed from the same substance as the first material, providing a flexible, chewable, and safe surface for a child's gums and teeth. In other embodiments, the platform 1404 and protrusions 1402 can be formed separately from the first material and afterwards bonded to the first material.

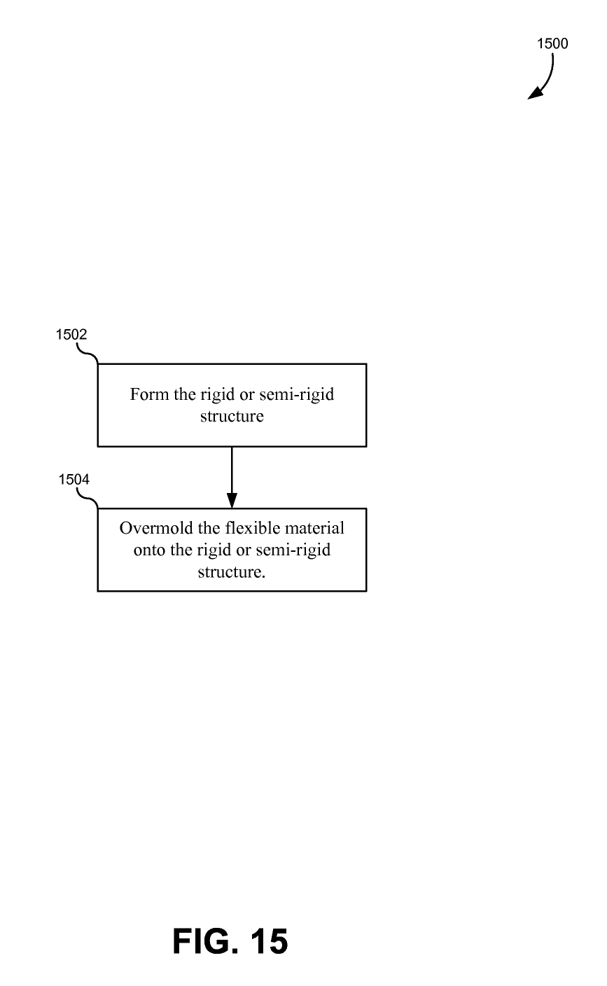

FIG. 15 illustrates a flowchart 1500 of method for constructing the child toothbrush, according to some embodiments. The method may include forming a rigid or semirigid structure (1502). The structure can be formed of any of the thermoplastic polymers, polyesters, or like materials described above. The structure can be formed through the use of injection molding or other similar procedures. The method may also include overmolding the flexible material onto the rigid or semi-rigid structure (1504). The rigid or semi-rigid structure can be inserted into a second mold and the flexible material—such as silicone—can be injected or compressed to fill the space around the rigid or semi-rigid structure. The second mold can also include protrusions or bristles that are molded and formed at the same time.

It should be appreciated that the specific steps illustrated in FIG. 15 provide particular methods of constructing a child toothbrush according to various embodiments of the present invention. Other sequences of steps may also be performed according to alternative embodiments. For example, alternative embodiments of the present invention may perform the steps outlined above in a different order. Moreover, the individual steps illustrated in FIG. 15 may include multiple sub-steps that may be performed in various sequences as appropriate to the individual step. Furthermore, additional steps may be added or removed depending on the particular applications. One of ordinary skill in the art would recognize many variations, modifications, and alternatives.

What is claimed is:

1. A child toothbrush comprising:
a hollow tube comprising:
a first end, the first end being open to allow a finger to enter the tube;
an outer surface;
a first material, wherein the first material is flexible; and
a second material, wherein the second material is less flexible than the first material; and
a plurality of protrusions distributed on the outer surface.

2. The method of claim 1, wherein the second material is rigid.

3. The method of claim 1, wherein the second material is semi-rigid.

4. The method of claim 1, wherein the second material forms a rigid or semi-rigid structure for the hollow tube.

5. The method of claim 1, wherein the second material comprises thermoplastic polymer or polyester.

6. The method of claim 1, wherein the second material comprises a plurality of rings.

7. The method of claim 1, wherein the second material comprises a spiral.

8. The method of claim 1, wherein the first material comprises silicone.

9. The method of claim 1, wherein the hollow tube further comprises a lip at the first end, the lip being formed from the first material.

10. The method of claim 1, wherein the hollow tube further comprises a second end opposite of the first end, the second end being close.

11. The method of claim 1, wherein the plurality of protrusions comprises bristles formed from the first material.

12. The method of claim 1, wherein the plurality of protrusions comprises rounded nubs.

13. The method of claim 1, wherein the plurality of protrusions are also distributed over a closed end of the hollow tube.

14. The method of claim 1, wherein the plurality of protrusions comprises a plurality of different bristle types.

15. A method of manufacturing a child toothbrush, the method comprising:
forming a rigid or semi-rigid structure; and
overmolding a flexible material onto the rigid or semi-rigid structure, wherein the flexible material comprises a plurality of protrusions.

16. A method of using a child toothbrush, the method comprising:
placing the child toothbrush on a finger of a user, wherein the child toothbrush comprises the child toothbrush of claim 1; and
brushing a child's teeth with the child toothbrush on the finger of the user.
